(19) United States
(12) Patent Application Publication
(10) Pub. No.: US 2007/0218856 A1
(43) Pub. Date: Sep. 20, 2007

(54) Receiver, transceiver and receiving method

(76) Inventor: Sami Vilhonen, Littoinen (FI)

Correspondence Address: Hollingsworth & Funk, LLC, Suite 125, 8009 34th Avenue South, Minneapolis, MN, 55425, US

(21) Appl. No.: 11/378,159

(22) Filed: Mar. 17, 2006

(51) Int. Cl. H04B 1/26

(52) U.S. Cl. 455/323

(57) ABSTRACT

A receiving method, a transceiver and a receiver are provided. The receiver comprises an antenna for receiving a radio frequency signal, a local oscillator, an amplifier for amplifying the received signal, a phase shifter connected between the antenna and the amplifier, the phase shifter converting a high impedance at one end of the phase shifter to a low impedance at the other end, and vice versa. The receiver further comprises a filter, the frequency response of the filter being determined on a frequency related to the frequency of the local oscillator, the filter comprising a switching arrangement which converts the frequency response to radio frequency.

### FIELD

The invention relates to filtering in receivers and transceivers, especially in RF receivers and transceivers.

### BACKGROUND

Receivers of telecommunication systems must tolerate high blocking signals while maintaining their own performance. The blocking signals may originate from nearby external transmitters and interferers. When a transceiver is concerned the cause of a blocking signal may be a transmitter of the same transceiver that is transmitting at the same time a receiver of the transceiver is receiving. The high output power of the transmitter may cause problems to the receiver receiving a very low level signal.

To avoid these blocking effects a duplex filter has been used in transceivers to isolate transceiver and receiver branches from each other. Furthermore, the receiver front end includes various filters in order to filter out-band blockers and interferers.

The use of these filters causes many difficulties to transceiver and receiver designers. Duplex filters are expensive and complicated and increase manufacturing costs.

So far, the receiver front end filters have been realized with SAW (surface acoustic wave) or BAW (bulk acoustic wave) filters or other resonators. These components are expensive, impossible to integrate with a standard CMOS or BiCMOS process and also require large areas of PWBs (printed wiring boards). Such filters also decrease the possibility of modularity and increase the number of I/O's (inputs/outputs) in RFIC's (radio frequency integrated circuits) thus increasing their complexity. Also, the insertion loss in the receiver front end is significant when considering the total noise figure of the receiver and the sensitivity that can be achieved with it.

Especially in cellular telecommunication systems, terminal equipment must support several different frequency bands. This kind of terminal equipment may be called a multiband transceiver. Currently, a multiband transceiver requires band specific filters. The design of band specific filters is complicated, as it requires switches to couple a signal through correct filters to the antenna and to the receiver.

### BRIEF DESCRIPTION OF THE INVENTION

An object of the invention is to provide an improved solution for filtering in a receiver and in a transceiver. According to an aspect of the invention, there is provided a receiving method in a transceiver, the method comprising: receiving a signal with an antenna, performing a phase shift in the signal received with the antenna, the phase shift converting a high impedance at one end of the phase shifter to a low impedance at the other end, and vice versa, amplifying the phase shifted signal in an amplifier, forming an impedance in an impedance circuitry at a frequency related to the frequency of a local oscillator of the transceiver, and switching the impedance to RF frequency at the input of the amplifier.

According to another aspect of the invention, there is provided a receiving method in a transceiver of a telecommunication system, the method comprising: receiving a signal with an antenna, amplifying the phase shifted signal in an amplifier, forming an impedance in an impedance circuitry at a frequency related to the frequency of a local oscillator of the transceiver, and switching the impedance to RF frequency at the input of the amplifier.

According to another aspect of the invention, there is provided a receiver comprising: antenna means for receiving a radio frequency signal, a local oscillator, amplifying means for amplifying the received signal, phase shifting means connected between the antenna means and the amplifier, the phase shifting means converting a high impedance at one end of the phase shifter to a low impedance at the other end, and vice versa, impedance circuitry means for forming an impedance at a frequency related to the frequency of the local oscillator, and switching means for switching the impedance of the impedance circuitry means to RF frequency at the input of the amplifying means.

According to another aspect of the invention, there is provided a transceiver comprising: antenna means for receiving and transmitting a radio frequency signal, at least one local oscillator, a transmitter and a receiver connected to the antenna means, the receiver comprising amplifying means for amplifying the received signal, phase shifting means connected between the antenna means and the amplifier, the phase shifting means converting a high impedance at one end of the phase shifter to a low impedance at the other end, and vice versa, impedance circuitry means for forming an impedance at a frequency related to the frequency of the local oscillator, and switching means for switching the impedance of the impedance circuitry means to RF frequency at the input of the amplifying means.

According to another aspect of the invention, there is provided a receiver comprising: an antenna for receiving a radio frequency signal, a local oscillator, an amplifier for amplifying the received signal, a phase shifter connected between the antenna and the amplifier, the phase shifter converting a high impedance at one end of the phase shifter to a low impedance at the other end, and vice versa, and a filter, the frequency response of the filter being determined on a frequency related to the frequency of the local oscillator, the filter comprising a switching arrangement which converts the frequency response to radio frequency.

According to yet another aspect of the invention, there is provided an integrated circuit comprising: an input port receiving a radio frequency signal, at least one clock input for receiving a clock signal having a frequency related to the frequency of a local oscillator, an amplifier for amplifying the received signal, an impedance circuitry for forming an impedance at a frequency of the signal at the clock input, and a switching arrangement for switching the impedance of the impedance circuitry to radio frequency at the input of the amplifier.

The embodiments of the invention provide several advantages. The proposed filtering arrangement may be implemented on the RFIC of the receiver or transceiver. There is no need for expensive and bulky external filters. Thus, the size and the cost of the filter are considerably lower than in the prior art solutions. Furthermore, the frequency response of the filter is better than in the prior art solutions. For example, a very wideband low noise amplifier input at the receiver may be achieved with a high selectivity. The insertion loss is significantly lower than with external filters.

The design of the proposed filtering arrangement is simple and it may be configured for use on different frequency bands with minimal changes. The change of the frequency band in use may be performed by software.

### LIST OF DRAWINGS

In the following, the invention will be described in greater detail with reference to the embodiments and the accompanying drawings, in which

FIG. 1 illustrates an example of a telecommunication system in which embodiments of the invention are applicable;

FIGS. 2A to 2C illustrate examples of the front end of a transceiver in which embodiments of the invention can be applied;

FIG. 3 illustrates an example of a band pass filter;

FIGS. 4A to 4C illustrate examples of a filter;

FIG. 5 illustrates yet another example of a band pass filter;

FIG. 6 illustrates an example of a low noise amplifier, and

FIG. 7 illustrates an example of an integrated circuit.

### DESCRIPTION OF EMBODIMENTS

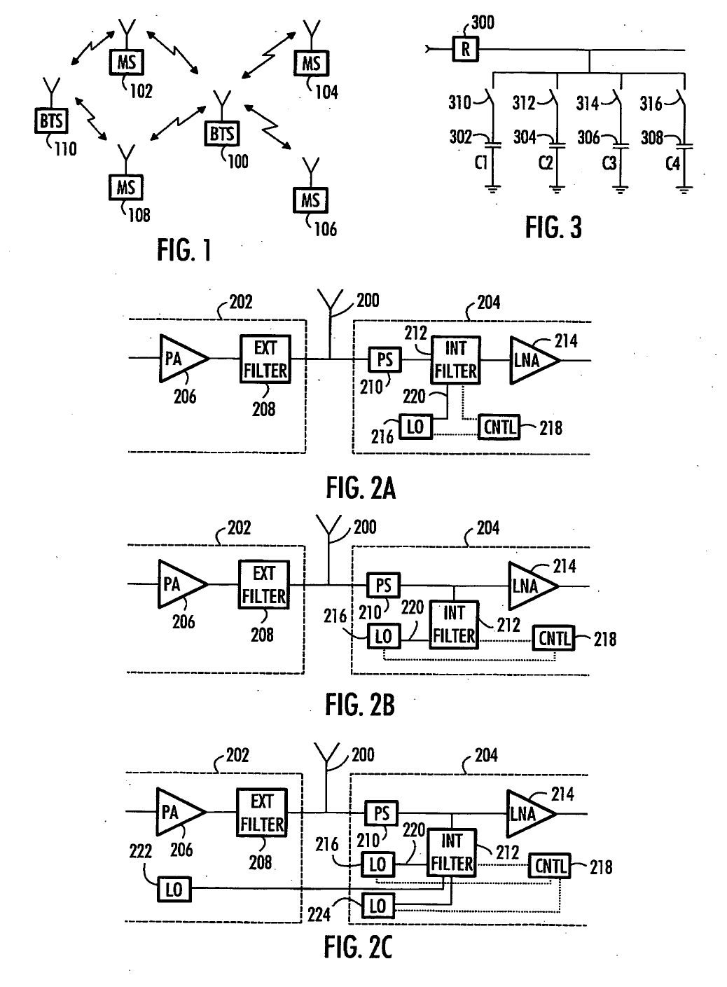

With reference to FIG. 1, let us examine an example of a telecommunication system in which embodiments of the invention are applicable. FIG. 1 shows a base station 100 which is in connection with terminal equipment 102, 104, 106 and 108. The terminal equipment 102 and 108 may also be in contact with another base station 110. The base station 100 and the terminal equipment 102, 104, 106 and 108 comprise an RF transceiver. Embodiments of the invention may be applied both in base stations and in terminal equipment.

Different multiple access methods may be used in the telecommunication system in which embodiments of the invention are applicable. The system may utilize CDMA (Code Division Multiple Access) WCDMA (Wide CDMA) or TDMA (Time Division Multiple Access), for example. The access method used is not relevant regarding the embodiments of the invention. Different connections within the system may interfere with each other.

Also, the transmitter and receiver of each transceiver may be the cause of a blocking signal with respect to each other. Embodiments of the invention are not limited to transceivers or receivers of telecommunication systems, but they may be applied to any transceiver and receiver, especially to any RF transceiver and RF receiver.

FIGS. 2A and 2B illustrate an example of the front end of a transceiver in which embodiments of the invention are applicable. The transceiver comprises an antenna 200 connected to a transmitter 202 and a receiver 204. The front end of the transmitter 202 comprises a power amplifier 206 and an external filter 208 between the antenna and the amplifier. The filter may be a SAW or a BAW filter, which blocks the signal received by the receiver 204 to reach the power amplifier 206 of the transmitter 202. Also other filter arrangements may be used. The power amplifier may be realized in ways known to one skilled in the art.

In the example of FIG. 2A, the front end of the receiver 204 comprises a phase shifter 210 connected to the antenna, an internal pass band filter 212 and a low noise amplifier 214 placed in series. In the example of FIG. 2B, the pass band filter 212 is connected in parallel with the low noise amplifier 214. In the following, embodiments where a series connection is used are presented. However, respective solutions may be used with a parallel connection as well, as one skilled in the art is aware. The low noise amplifier may be realized in ways known to one skilled in the art.

The receiver 204 also comprises a local oscillator 216 and a controller unit 218 controlling the operation of the receiver. The controller unit may be realized with a processor and associated software or with discrete logic circuits. The local oscillator generates a clock signal 220 to various units of the receiver, for example to the filter 212.

The internal pass band filter 212 generates impedance at the input of the low noise amplifier 214. At the frequency band used by the receiver the pass band filter 212 generates a pass band response, which has very good frequency characteristics. Outside the desired frequency band of the receiver the impedance at the input of the amplifier is very low. The phase shifter is selected such that it converts this impedance to a very high value at the antenna side. Thus, outside the desired band, no power enters into the receiver, but is instead reflected back to the antenna. The phase shifter may be realized as a lambda/4 transformer, for example. It may be a coaxial line that is ¼ of a wavelength of the received signal, for example. The phase shifter may also be realized with a 5/4 lambda transformer, with RC or RLC components or any other phase shifter with suitable phase shifting properties, as one skilled in the art is aware of.

At the frequency band used by the receiver the pass band filter 212 generates a frequency response which has a narrow pass band and a very steep shape.

FIG. 3 illustrates an example of a band pass filter 212. The filter comprises a resistor 300 having a resistance of R and four capacitors 302, 304, 306 and 308 placed in parallel. The capacitors have capacitances C1, C2, C3 and C4, respectively. Each capacitor is placed behind a switch 310, 312, 314, and 316. The switches are controlled to switch four parallel capacitors alternately so that each one of them is on 25% of the time cycle. The switching frequency of the capacitor switches 310, 312, 314, and 316 is related to the local oscillator frequency. If the input RF frequency differs from the switching frequency of the capacitor switches 310, 312, 314, and 316, the capacitors are charged with the frequency difference and create a band pass filter response with a corner frequency of

$$τ = \frac{1}{2 π RC} ,$$

where C=C1+C2+C3+C4.

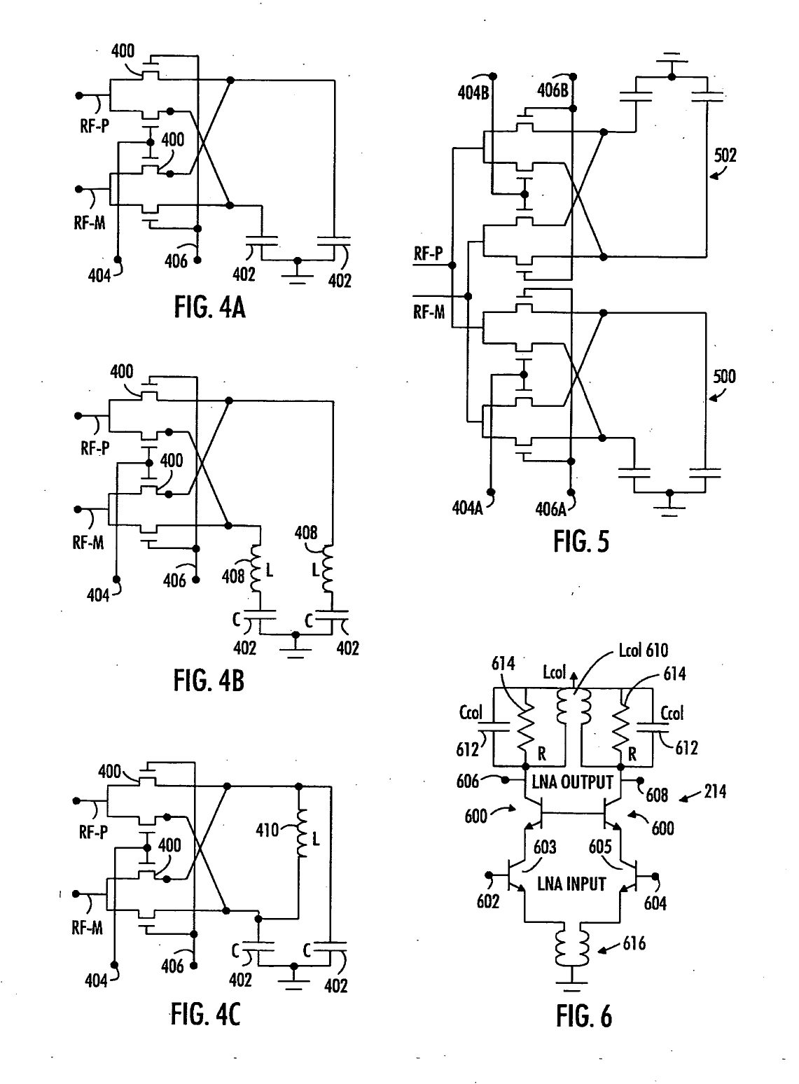

The band pass filter 210 is further described in FIGS. 4A, 4B and 4C which are examples among others of a simplified schematic view of the filter 210. The embodiments of FIGS. 4A, 4B and 4C use MOSFETs (metal-oxide-semiconductor field-effect transistors) as switches.

In an embodiment of the invention shown in FIG. 4A, the filter comprises MOSFET switches 400, which are switched with signals 404, 406 between on and off states. The frequency of the signals 404, 406 is related to LO (local oscillator) signal. The filter further comprises capacitors C 402 connected to the switches 400. As the MOSFETs 400 are switched between on and off states the capacitors are then switched between RF-P and RF-M ports which act as input to the MOSFETs. Referring to FIG. 2B, the ports RF-P and RF-M are input signals of the low noise amplifier. The amplifier has a differential input. The resistance R is the output resistance of the phase shifter. It should be noted here that the resistor R may be a general impedance of the form of Z=a+bj ohms. Thus, it is not necessarily a pure resistor. The resistance R is used here for simplicity.

In an embodiment of the invention, the frequency of the signals 404 and 406 is not exactly the same as the frequency of a local oscillator signal but derived from it.

If the frequency of the incoming RF signals in ports RF-P and RF-M differ from the frequency of the signals 404, 406, then the capacitors C 402 will be charged with a signal, the frequency of which is the difference of the RF and signals 404, 406. The driving impedance is the impedance R of the resistor R 300. Therefore the result is impedance filtering at frequency F_{LO}+F_{RC}, where F_{LO} is the LO-signal frequency and F_{RC} is the corner frequency of the resistor R 300 and the capacitor C 402 (i.e., ½πRC).

This means that the filter 210 is a band pass filter with pass band corner frequencies (also called −3 dB frequencies or half-power frequencies) F_{LO}+F_{RC} and F_{LO}-F_{RC}, respectively.

The shape of the filter 210 is very steep, since the attenuation increases as a function of the RC constant corresponding to low frequencies. Let us study an example. If the LO frequency is 2 GHz and an RC time constant is equivalent to 2 MHz, then the signal of frequency 2.002 GHz attenuates 3 dB. If a standard RC −3 dB point at that frequency, 20 dB attenuation would be reached at the frequency of about 20.002 GHz (i.e. one decade away). With the transferred-impedance filter 210, the 20 dB attenuation will be reached at 2.020 GHz (i.e. one decade away from the RC frequency 2 MHz). Thus, the low frequency (defined by the RC constant) is transferred to the RF frequencies. This is a significant improvement over the prior art solutions.

Thus, in an embodiment of the invention, the filter comprises means for forming impedance at a frequency derived from the frequency of the local oscillator and switches for switching the impedance to the frequency.

It is noted that other impedances can be transferred to higher frequency filtering using the methodology described in the present invention. In the embodiment of FIG. 4A, capacitors 402 were used as impedance in the filter 210. However, any impedance Z may replace the capacitors. The capacitors 402 in FIG. 4A can be replaced with an LC-resonator or with a combination of capacitors and an amplifier, for example. The impedance created with a LC-resonator is especially attractive in CDMA2000 handsets which must tolerate high blocker only 900 kHz away from its own LO-frequency. FIGS. 4B and 4C demonstrate LC resonator options.

In the embodiment of FIG. 4B, inductors L 408 are added in series with the capacitors C 402 (compared to FIG. 4A) and the center frequency of the filter (or a reference frequency) is given by F_{LO}-F_{LC} or F_{LO}+F_{LC}, wherein F_{LO} is the local oscillator frequency 404, 406 provided to the filter 210 and F_{LC} is an LC resonant frequency given by F_{LC}=½π\sqrt{LC}. F_{LC} can be made as low as 900 kHz, for example. In this case, the resultant center frequency of the filter could be F_{LO}-900 kHz or F_{LO}+900 kHz (e.g., this may be important in CDMA2000).

Moreover, according to an embodiment shown in FIG. 4C, an inductor L 410 is added in parallel with the capacitors C 402 (compared to FIG. 4A) with an LC resonant frequency F_{LC} given by F_{LC}=½π\sqrt{LC}. It is noted that for the resonant curve with the center frequencies F_{LO}+F_{LC} and F_{LO}-F_{LC}, the corner frequencies (−3 dB frequencies) of the pass band depends on the inductor L 410 (in addition to being a function of the resistor R 300 and the capacitors C 402). Thus, if the inductor L 410 and the capacitor C 402 are placed in parallel, then there are narrow pass bands around the resonant frequency at F_{LO}+F_{LC} and F_{LO}-F_{LC} where F_{LC}=½π\sqrt{LC}.

The inductors 408 or 410 can be generated, e.g. from capacitors with operational amplifiers (which imitate inductors) or by providing a second (or higher) order filter by generating an impedance with a magnitude degrading as a second order filter response, thus providing a low area, high performance filter systems.

There are a lot of variations of the above-presented structure of the filter 210. It is noted that according to the present invention, NMOS switches, typically used in examples of FIGS. 4A, 4B and 4C, can be of other types. Moreover, the filter 210 does not necessarily have to be connected at the input of the low noise amplifier. The same effect, i.e. the band pass impedance, may be achieved by connecting the filter 210 to other parts of the receiver as well. For example, the filter may be connected to the output of the amplifier. In addition, the filter may be connected to the biasing ports of the low noise amplifier. Also, it is clearly understood that the technology described in the invention can provide a broad range of LC resonant frequencies and impedances transferred to filtering of radio frequencies, according to the present invention. Furthermore, the examples presented in the above-described Figures use differential (i.e. both positive and negative) signals but the method of the present invention can be also used in single-ended systems with only one signal line.

The frequency of the signals 404, 406 is related to LO (local oscillator) signal. The frequency may be derived from the frequency of the local oscillator signal or it may be locked to the frequency of the local oscillator signal. The signals may be generated in the local oscillator or in a separate oscillator.

Referring to the example of FIG. 2C, the receiver 204 and the transmitter 202 of a transceiver may comprise separate local oscillators 216, 222. The signals 404, 406 may be generated either in the oscillator of the transmitter or in the oscillator of the receiver or in a separate oscillator 224. The oscillator used in to generate the signals may be locked to the local oscillator.

FIG. 5 illustrates a more complete example of a band pass filter 210. In the example of FIG. 5, the filter comprises separate I- and Q-branches 500, 502. As input there are signals RF-P and RF-M as in the example of FIG. 4A. In this embodiment, there are four signals derived from a local oscillator signal. On the I-branch 500 of the filter there are F_{LO-IP} 404A and F_{LO-IM} 406A. On the Q-branch 502 of the filter there are F_{LO-QP} 404B and F_{LO-OM} 406B. The phase difference of F_{LO-IP} and F_{LO-QP} is 90 degrees and the phase difference of F_{LO-IM} and F_{LO-QM} is like wise 90 degrees. The phase difference of F_{LO-IP} and F_{LO-IM} is 180 degrees and the phase difference of F_{LO-QP} and F_{LO-QM} is 9 like wise 0 degrees.

FIG. 6 illustrates a simplified example of a low noise amplifier 214. The example is a typical differential bipolar LNA. It should be noted that biasing connections have been omitted for simplicity.

The amplifier of FIG. 6 comprises and uses a differential transistor pair 600. The amplifier comprises input ports RF_{IN-P} 602 and RF_{IN-M} 604 connected to the bases of transistors 603, 605, respectively, and output ports RF_{OUT-M} 606 and RF_{OUT-P} 608. In FIG. 6, inductors L_{COL} 610 compensate for the capacitive part of the LNA output (i.e., amplified RF signals 606, 608). The capacitive part comprises the capacitor C_{COL} 612. Thus, capacitances are compensated by the inductors 610 such that an absolute value of a reactive component of the amplified RF signal 606, 608 is close to zero and negligible compared to a resistive component of said amplified RF signal 22 determined by the resistance 614. The emitter inductors 616 are used to improve input matching of the amplifier.

The ports RF-P and RF-M of the filter 210 of FIG. 5 may be connected to the input port RF_{IN-P} 602 and RF_{IN-M} 604, respectively. When the RF-signal is near the frequency derived from the local oscillator frequencies the filter 210 is provided with high impedance. Thus, it allows the signal to enter the amplifier. When the RF-signal is away from the frequency derived from the local oscillator frequencies (i.e, on the stop band) the filter 210 short circuits the amplifier input into ground potential.

By controlling the frequency derived from the local oscillator, the center frequency of the pass band of the filter 210 may be adjusted. Thus, the same filter may be used on different frequency bands and fixed frequency band specific filters with several switches in the receivers may be avoided. Referring to FIGS. 2A and 2B, the controller unit 218 of the receiver controls the filter 210, the local oscillator and the frequencies derived from the local oscillator.

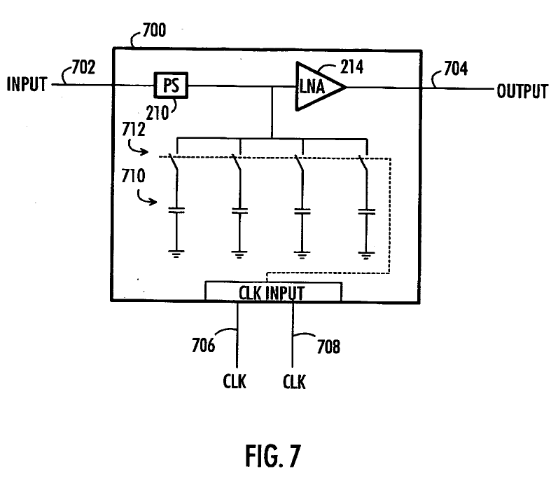

In an embodiment, the various aspects of the invention are realized on an integrated circuit which may be utilized in a transceiver or a receiver. The integrated circuit may be the RFIC (radio frequency integrated circuit) of a transceiver or a receiver realizing the radio frequency units of the transceiver or a receiver. Referring to FIG. 7, the integrated circuit (IC) 700 may comprise an input port 702 receiving a radio frequency signal from an antenna (not shown) and an output port 704. The IC may comprise at least one clock input 706, 708 for receiving a clock signal. A clock signal may be provided by a local oscillator of the transceiver or receiver. Oscillator generating the clock input may also be integrated on the same IC 700. A clock signal may have a frequency related to the frequency of the local oscillator.

In an embodiment, the IC comprises two clock inputs 706, 708, one for the local oscillator signal and one for the signal having a frequency related to the frequency of the signal provided by the local oscillator. The IC may comprise an amplifier 214 for amplifying the received signal, an impedance circuitry 710 for forming an impedance at a frequency of the signal at the clock input, and a switching arrangement 712 for switching the impedance of the impedance circuitry to radio frequency at the input of the amplifier. The integrated circuit may further comprise a phase shifter 210 connected between the input port and the amplifier, the phase shifter converting a high impedance at one end of the phase shifter to a low impedance at the other end, and vice versa.

There are many variations of the present invention. For example, in a system where transmission and reception does not occur simultaneously, such as the GSM system, the phase shifter may be replaced with a traditional switch between the antenna and the transmitter and the receiver.

In an embodiment, the invention is applied to a multiband transceiver which supports several frequency bands. The transceiver may comprise more than one local oscillator and more than one low noise amplifier. When the transceiver is transmitting and receiving on a given frequency band, the local oscillator and the low noise amplifier of the given band is used and switched to the filter 210. The switching may be performed under control of the controller unit 218 of the transceiver.

Even though the invention has been described above with reference to an example according to the accompanying drawings, it is clear that the invention is not restricted thereto but it can be modified in various ways within the scope of the appended claims.

1. A receiving method in a transceiver, the method comprising,
receiving a signal with an antenna, performing a phase shift in the signal received with the antenna, the phase shift converting a high impedance at one end of the phase shifter to a low impedance at the other end, and vice versa,
amplifying the phase shifted signal in an amplifier,
forming an impedance in an impedance circuitry at a frequency related to the frequency of a local oscillator of the transceiver, and
switching the impedance to RF frequency at the input of the amplifier.

2. The method of claim 1, further comprising controlling the switching with signals having a frequency related to the frequency of the local oscillator of the transceiver.

3. The method of claim 1, further comprising
realizing the phase shifting means with a lambda/4 waveguide.

4. The method of claim 1, further comprising
realizing the phase shifting means with RC or RLC components.

5. The method of claim 1, further comprising
controlling the center frequency of the pass band of the filter by adjusting the frequency related to the frequency of the local oscillator of the transceiver.

6. The method of claim 1, wherein the frequency related to the frequency of the local oscillator is derived from the frequency of the local oscillator.

7. The method of claim 1, wherein the frequency related to the frequency of the local oscillator is locked to the frequency of the local oscillator.

8. A receiving method in a transceiver of a telecommunication system, the method comprising,
receiving a signal with an antenna, amplifying the phase shifted signal in an amplifier,
forming an impedance in an impedance circuitry at a frequency related to the frequency of a local oscillator of the transceiver, and
switching the impedance to RF frequency at the input of the amplifier.

9. A receiver comprising
antenna means for receiving a radio frequency signal, a local oscillator,
amplifying means for amplifying the received signal,
phase shifting means connected between the antenna means and the amplifier, the phase shifting means converting a high impedance at one end of the phase shifter to a low impedance at the other end, and vice versa,
impedance circuitry means for forming an impedance at a frequency related to the frequency of the local oscillator, and
switching means for switching the impedance of the impedance circuitry means to RF frequency at the input of the amplifying means.

10. The receiver of claim 9, wherein the switching means are controlled by signals having a frequency related to the frequency of the local oscillator of the receiver.

11. The receiver of claim 9, wherein the impedance circuitry means and the switching means short circuit the input of the amplifying means when the frequency of the radio frequency signal deviates more than a predetermined pass band width from the frequency derived from the frequency of the local oscillator of the receiver.

12. The receiver of claim 9, wherein the impedance circuitry means and the switching means create a high impedance at the input of the amplifying means when the frequency of the radio frequency signal deviates less than a predetermined pass band width from the frequency derived from the frequency of the local oscillator of the receiver.

13. The receiver of claim 9, wherein the impedance circuitry means and the switching means are connected between the phase shifting means and the amplifying means.

14. The receiver of claim 9, wherein the frequency related to the frequency of the local oscillator is derived from the frequency of the local oscillator.

15. The receiver of claim 9, wherein the frequency related to the frequency of the local oscillator is locked to the frequency of the local oscillator.

16. The receiver of claim 9, further comprising generator means for generating the frequency related to the frequency of the local oscillator.

17. A transceiver comprising
antenna means for receiving and transmitting a radio frequency signal, at least one local oscillator, a transmitter and a receiver connected to the antenna means, the receiver comprising
amplifying means for amplifying the received signal,
phase shifting means connected between the antenna means and the amplifier, the phase shifting means converting a high impedance at one end of the phase shifter to a low impedance at the other end, and vice versa,
impedance circuitry means for forming an impedance at a frequency related to the frequency of the local oscillator, and
switching means for switching the impedance of the impedance circuitry means to RF frequency at the input of the amplifying means.

18. The transceiver of claim 17, wherein the frequency related to the frequency of the local oscillator is derived from the frequency of the local oscillator.

19. The transceiver of claim 17, wherein the frequency related to the frequency of the local oscillator is locked to the frequency of the local oscillator.

20. The transceiver of claim 17, further comprising generator means for generating the frequency related to the frequency of the local oscillator.

21. A receiver comprising
an antenna for receiving a radio frequency signal,
a local oscillator,
an amplifier for amplifying the received signal,
a phase shifter connected between the antenna and the amplifier, the phase shifter converting a high impedance at one end of the phase shifter to a low impedance at the other end, and vice versa, and
a filter, the frequency response of the filter being determined on a frequency related to the frequency of the local oscillator, the filter comprising a switching arrangement which converts the frequency response to radio frequency.

22. An integrated circuit comprising
an input port receiving a radio frequency signal, at least one clock input for receiving a clock signal having a frequency related to the frequency of a local oscillator,
an amplifier for amplifying the received signal,
an impedance circuitry for forming an impedance at a frequency of the signal at the clock input, and
a switching arrangement for switching the impedance of the impedance circuitry to radio frequency at the input of the amplifier.

23. The integrated circuit of claim 22, further comprising
a phase shifter connected between the input port and the amplifier, the phase shifter converting a high impedance at one end of the phase shifter to a low impedance at the other end, and vice versa.
